(19) United States
(12) Patent Application Publication
(10) Pub. No.: US 2022/0255390 A1
(43) Pub. Date: Aug. 11, 2022

(54) ELECTRICAL WINDING FOR A ROTARY ELECTRIC MACHINE

(71) Applicant: VALEO EQUIPEMENTS ELECTRIQUES MOTEUR, Creteil Cedex (FR)

(72) Inventors: Maxime GROSPEAUD, Creteil Cedex (FR); Alexandre SCHMITT, Creteil Cedex (FR); Pierre FAVEROLLE, Creteil Cedex (FR); Wojciech MANDOK, Czechowice (PL); Clement BERNARD, Creteil Cedex (FR); Stephane DE CLERCQ, Creteil Cedex (FR); Paul ARMIROLI, Creteil Cedex (FR); Damien LE GAC, Creteil Cedex (FR)

(73) Assignee: VALEO EQUIPEMENTS ELECTRIQUES MOTEUR, Creteil Cedex (FR)

(21) Appl. No.: 17/765,747

(22) PCT Filed: Oct. 1, 2020
(86) PCT No.: PCT/EP2020/077564

§ 371 Date: Mar. 31, 2022

(30) Foreign Application Priority Data
Oct. 4, 2019 (FR) FR1910985

(51) Int. Cl. H02K 3/50; H02K 3/28; H02K 3/12

(52) U.S. Cl. CPC H02K 3/50; H02K 3/12; H02K 3/28

(57) ABSTRACT

A winding for an active part of a rotary electric machine having at least one phase system. The winding includes a plurality of phases each including a first power supply pin and a second power supply pin each forming a phase input or output, each power supply pin including a power supply end that extends outside the slot and extends a conductive segment that extends inside the slot. At least one portion of a first power supply end is arranged on an inner periphery of the winding, the first end extending a conductive segment arranged in an external layer and at least one portion of a second power supply end is arranged on an outer periphery of the winding, said second end extending a conductive segment arranged in an internal layer, the inner periphery being closer to the axis than the outer periphery and the internal and external layers forming edge layers.

The invention particularly relates to an electrical winding for an active part, such as a stator or a rotor, of a rotary electric machine. The invention more particularly relates to an electrical winding produced using conductive pins.

The invention is particularly advantageously applicable in the field of rotary electric machines such as alternators, starter-alternators, or even reversible machines or electric motors. It will be recalled that a reversible machine is a rotary electric machine that is able to operate reversibly, both as an electric generator when functioning as an alternator and as an electric motor for example for starting the combustion engine of the motor vehicle.

A rotary electric machine comprises a rotor free to rotate about an axis, and a fixed stator. The stator comprises a body having a yoke forming a part for rotating about an axis passing through the center of the stator. The body comprises teeth that extend radially from the yoke toward the center of the stator and that define slots around which an electrical winding is positioned. The winding is formed by a plurality of conductive pins partially housed in the slots of the body and electrically connected in pairs via their ends in order to form a continuous electrical path. For example, each pin comprises two substantially parallel conductive segments connected by an elbow joint so as to form a U shape. The conductive segments are inserted on a first axial end face of the stator into two distinct slots, such that the conductive segments are substantially parallel to the axis of rotation of the stator. The same slot can house a plurality of segments belonging to distinct pins, thus forming different conductive segment layers.

The free ends of the conductive segments, protruding beyond a second axial end face of the stator, are subsequently connected together so as to form electrical paths generating magnetic fields along the teeth of the body when an electric current passes through them. In other words, the conductive pins are connected in pairs so as to form different sets, and each set can in particular correspond to an electrical power supply phase. For example, the stator comprises three distinct sets in order to allow the winding to be powered with three-phase current.

Such a winding requires a certain number of connections between the power supply pins forming the inputs and outputs of each phase in order to connect the phases to each other and thus ensure the coupling of the desired winding, and between the power supply pins and the corresponding electronic power modules in order to connect said inputs and outputs of each phase to said modules.

Depending on the structure of the winding, the power supply pins can be situated in the slot on external layers of the winding. In this case, the power supply pins are thus not radially surrounded by other pins. As a result, the power supply pins that only comprise a single conductive segment are not securely retained in the slot. In particular, their free end can move radially toward the outside of the winding. The free ends can then come into contact with another element of the rotary electric machine such as the rotor, for pins positioned on the internal layer of the stator, or one of the flanges of the casing, for pins positioned on the external layer of the stator, and damage the rotary electric machine. The free ends can also press on the teeth of the stator body or of the yoke and thus damage the enamel covering them and create short circuits.

The aim of the present invention is to avoid the disadvantages of the prior art. To this end, the present invention therefore relates to an electrical winding for an active part, particularly formed by a stator or a rotor, of a rotary electric machine, the active part comprising a body having an annular yoke around an axis and a plurality of teeth extending from a lateral face of the yoke in a radial direction so as to define slots, said slots being open on a first axial end face and on a second axial end face of the body. The electrical winding has at least one phase system comprising a plurality of electrical phases each including a set of pins that are electrically connected to each other and each of which has at least one conductive segment, said conductive segments being suitable for being housed in the same slot forming N layers. Said set of pins comprises at least a first power supply pin and a second power supply pin, each forming a phase input or output. According to the invention, each power supply pin comprises a power supply end extending from the associated conductive segment to the outside of the slot. Still according to the invention, at least part of a first power supply end is arranged on an inner periphery of the winding, said first end extending a conductive segment arranged in an external layer. In addition, according to the invention, at least part of a second power supply end is arranged on an outer periphery of the winding, said second end extending a conductive segment arranged in an internal layer, the inner periphery being closer to the axis than the outer periphery and said internal and external layers forming edge layers.

In other words, the first power supply end and the second power supply end each have an intersecting portion arranged circumferentially facing each other.

This makes it possible to exert a force in a radial direction on the power supply end in order to thus make it possible to retain said power supply end and prevent said end from moving and coming into contact with either the rotor or the casing of the rotary electric machine. By connecting a portion of a power supply end, the associated conductive segment of which is arranged in the external layer of the winding, on an inner periphery, to the electronic assembly, a force is created in an inwardly radial direction on the power supply end, preventing it from protruding radially outward beyond the bundle and thus coming into contact with the machine casing. Similarly, by connecting a portion of a power supply end, the associated conductive segment of which is arranged in the internal layer of the winding, on an outer periphery, to the electronic assembly, a force is created in an outwardly radial direction on the power supply end, preventing it from protruding radially inward beyond the bundle and thus coming into contact with the machine rotor. This makes it possible to avoid damaging said power supply ends, particularly by preventing the creation of short circuits, and also to prevent more general damage to the rotary electric machine.

According to one embodiment, the first power supply pin extends in an external layer of a slot and the second power supply pin extends in an internal layer of a slot, said internal and external layers forming edge layers.

For example, the conductive segments of said first and second power supply pins are arranged in the external layer and in the internal layer of the same slot respectively.

The fact that the two power supply ends of the same slot each have an intersecting portion makes it possible to perform this function of retaining said ends in a radial direction while simplifying the connections between the electronic assembly and the power supply pins by preventing two connections from being too close to each other.

“Edge layer” is given to mean a layer located at an internal or external radial end of the winding, that is, a layer that is not central. In other words, the power supply pins are positioned in layers respectively forming the inner periphery and the outer periphery of the winding. This positioning of the power supply pins in edge layers as opposed to central layers makes it possible to simplify the connections between the coils within the phase by making it possible to make these connections between central layers that are therefore adjacent.

According to one embodiment, each slot comprises N segments belonging to different pins. For example, a layer is formed by a single segment of a pin.

According to one embodiment, the first end and the second end are spaced apart from each other in a circumferential direction. In other words, the intersecting portions are spaced apart from each other and are not therefore in contact. This makes it possible to avoid potential short circuits between the power supply ends.

According to one embodiment, said first and second power supply ends each have a linking portion adjacent to the associated conductive segment, a connecting portion suitable for being connected to an electronic assembly of the electric machine and an intersecting portion arranged between said associated linking and connecting portions, said linking and connecting portions of the same power supply end being on opposite sides of the intersecting portion of said same power supply end in a radial direction and the intersecting portions of the first and second power supply ends extending facing each other, in a circumferential direction.

According to one embodiment, the pins are suitable for forming bundles on either side of the axial end faces of the stator body respectively. In this embodiment, the intersecting portions are arranged axially at a distance from the bundles. This makes it possible to avoid excessive force being placed on the linking portion of the power supply ends by an excessive bending angle, which could particularly damage the enamel of the conductor and create short circuits. This also makes it possible to space the linking portion apart from the bundle and thus avoid the creation of short circuits. This distance must not however be too great so as not to increase the footprint of the rotary electric machine.

According to one embodiment, the intersecting portions extend between the outer periphery and the inner periphery of the winding and particularly in a radially central portion between said peripheries. This makes it possible to simplify the method for producing the winding by applying the same forces to the power supply ends. Alternatively, the intersecting portions can extend in an internal edge portion or an external edge portion of the winding.

According to one embodiment, a first set, arranged on one of the peripheries of the winding and made up of power supply pins of different phases, comprises at least one power supply end having an intersecting portion and at least one other power supply end that does not have an intersecting portion. In this embodiment, a second set, arranged on a different periphery of the winding from the first set and made up of power supply pins of different phases, comprises at least one power supply end having an intersecting portion and at least one other power supply end that does not have an intersecting portion.

Each of the sets therefore comprises at least one power supply end forming a phase input and one other power supply end forming a phase output. The phase inputs and outputs to be connected together are thus positioned so that there is no longer any need to overlap or intersect interconnection tracks to achieve a delta configuration. This makes it possible to simplify the structure of the interconnector and reduce its footprint.

A power supply end that does not have an intersecting portion is given to be a power supply end extending substantially axially on the same periphery as the one in which its associated conductive segment is arranged.

For example, in a set comprising at least three first ends, only two or one of said ends have/has an intersecting portion.

Alternatively, all of the power supply ends could have intersecting portions.

By way of further example, when a set comprises two power supply ends having intersecting portions, the power supply end that does not have an intersecting portion is arranged circumferentially between said end portions having an intersecting portion. Similarly, when a set comprises one power supply end having an intersecting portion, said power supply end having the intersecting portion is arranged circumferentially between the end portions that do not have intersecting portions.

This alternation between the ends having intersecting portions and the ends that do not have intersecting portions makes it easy to alternate the phase inputs and outputs within the same set. This makes it possible to avoid intersections between interconnection tracks connecting an input to an output, while preventing one of said tracks from protruding radially in order to make the electrical connection while avoiding one of the ends positioned on the same stator circumference.

According to one embodiment, the winding comprises at least one retaining member arranged to retain, at least in a radial direction, two power supply ends that do not have intersecting portions.

The retaining member makes it possible to retain the power supply ends of the power supply pins to prevent said ends from moving and coming into contact with either the stator body or the rotor or the casing of the rotary electric machine.

The retaining member can form an interconnector making it possible to connect the power supply ends to each other or to connect the power supply ends to the electronic assembly.

The retaining member can comprise a conductive track. For example, the conductive track can be at least partially covered by an electrically insulating material.

Alternatively, the retaining member can be formed solely from an electrically insulating material.

According to one embodiment, the pins other than the power supply pins are each formed of two conductive segments connected to each other at one of their ends extending from the first axial end face of the body, known as the first end, and connected to different pins at the other of their ends extending from the second axial end face of the body, known as the second end, the first ends of the power supply pins extending from said first axial end face.

According to one embodiment, the first power supply pin has a different shape from the second power supply pin. For example, each power supply pin has a single conductive segment and two ends. By way of further example, the two ends of the first power supply pin extend in opposite circumferential directions from each other and the two ends of the second power supply pin extend in the same circumferential direction.

According to this embodiment, the winding comprises a first group of conductive pins the conductive segments of which are each positioned in two distinct layers separated from each other by at least one intermediate layer, a second group of conductive pins the conductive segments of which are each positioned in two distinct layers separated from each other by at least one at least one intermediate layer, the layers comprising the first group of pins being distinct from the layers comprising the second group of pins, and a connecting pin making it possible to connect the first group of pins to the second group of pins.

According to one embodiment, the conductive segments of the connecting pin are arranged in two adjacent layers. “Adjacent layers” is given to mean successive layers that are not separated by another layer. This allows the insertion of the pins during the method for producing the winding to be simplified and also allows the shape of the connecting pin to be simplified.

According to one embodiment, the adjacent layers in which the conductive segments of the connecting pin are positioned are central layers. “Central layer” is given to mean a layer that is surrounded by two other layers and is not therefore on the edge of the slot.

According to one embodiment, each conductive segment of a power supply pin is suitable for being positioned in one of the slots comprising a conductive segment of a connecting pin.

According to one embodiment, the power supply pins make it possible to connect the winding to an electronic power and/or control module.

According to one embodiment, each phase comprises a plurality of conductive pins, at least one connecting pin and a number of power supply pins equal to twice the number of connecting pins.

According to one embodiment, the layers comprising the conductive segments of the conductive pins of the first group of pins are alternated with the layers comprising the conductive segments of the conductive pins of the second group of pins. For example, the internal radial layer comprises a conductive segment of a conductive pin of the first group of pins and the external radial layer comprises a conductive segment of a conductive pin of the second group of pins.

According to one embodiment, the conductive pins of the first group of pins respectively have different shapes from the conductive pins of the second group of pins.

According to one embodiment, the conductive pins of the first group of pins each comprise two free ends respectively extending the two conductive segments, said ends being curved so as to come closer to each other in a circumferential direction.

According to one embodiment, the conductive pins of the second group of pins each comprise two free ends respectively extending the two conductive segments, said ends being curved so as to diverge from each other in a circumferential direction.

The present invention also relates to an active part of a rotary electric machine, particularly formed by a stator or a rotor, which comprises an electrical winding as previously described.

Moreover, the present invention also relates to a rotary electric machine comprising an active part, particularly formed by a stator or a rotor, which comprises an electrical winding as previously described. The rotary electric machine can advantageously form an alternator, a starter-alternator, a reversible machine or an electric motor.

The present invention will be better understood from reading the following detailed description of non-limiting embodiments of the invention and with reference to the appended drawings.

FIG. 1 schematically shows a partial cross-sectional view of an example of a rotary electric machine.

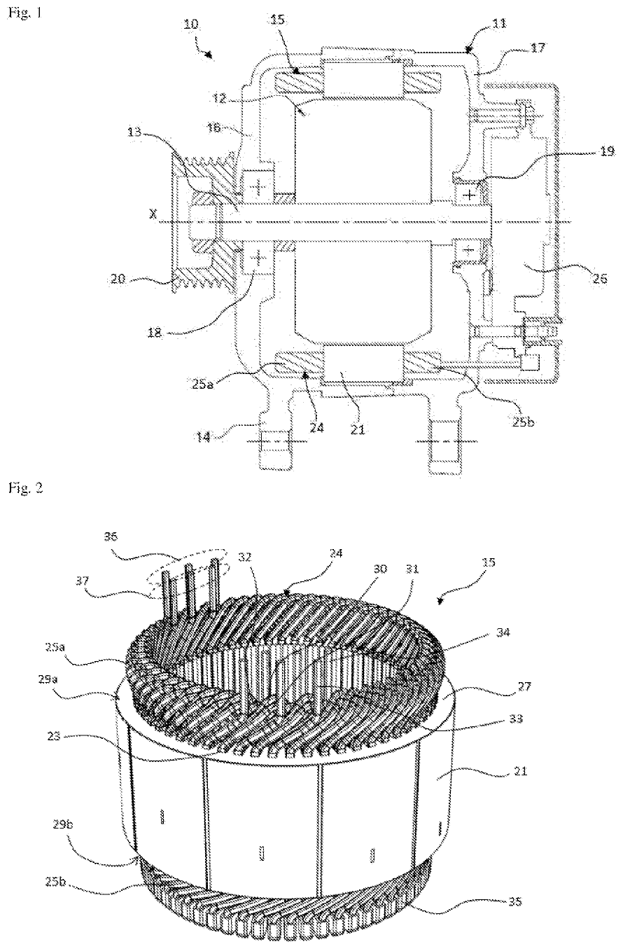

FIG. 2 schematically shows a perspective view of the stator of FIG. 1.

FIG. 3 schematically shows a cross-sectional view along a radial plane of a portion of the stator of FIG. 2.

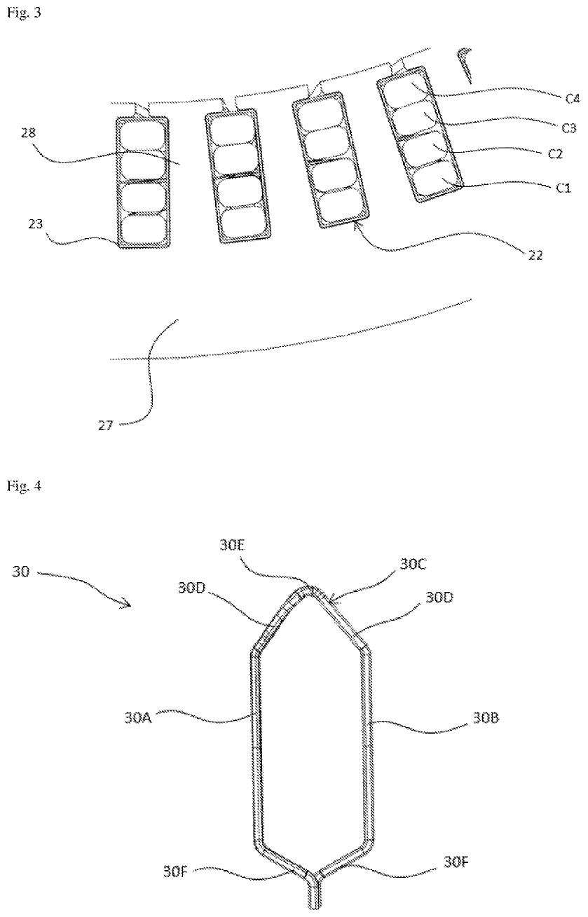

FIG. 4 schematically shows a perspective view of a conductive pin of the first group of pins of the stator of FIG. 2.

FIG. 5 schematically shows a perspective view of a conductive pin of the second group of pins of the stator of FIG. 2.

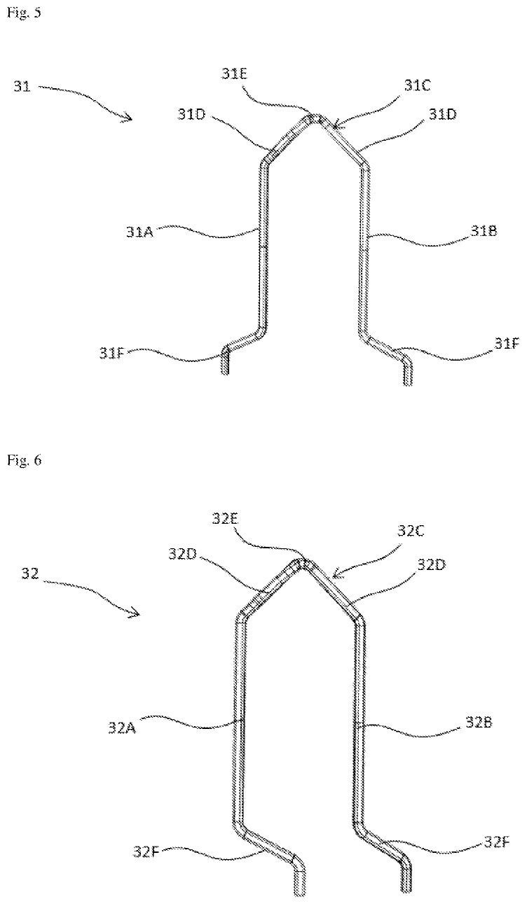

FIG. 6 schematically shows a perspective view of a connecting pin of the stator of FIG. 2.

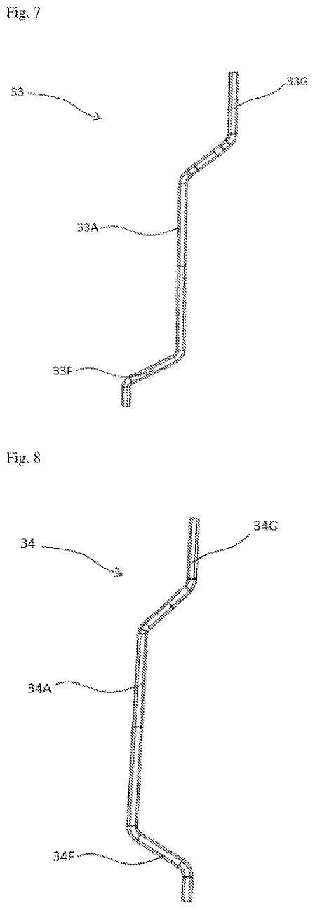

FIG. 7 schematically shows a perspective view of a first power supply pin of the stator of FIG. 2.

FIG. 8 schematically shows a perspective view of a second power supply pin of the stator of FIG. 2.

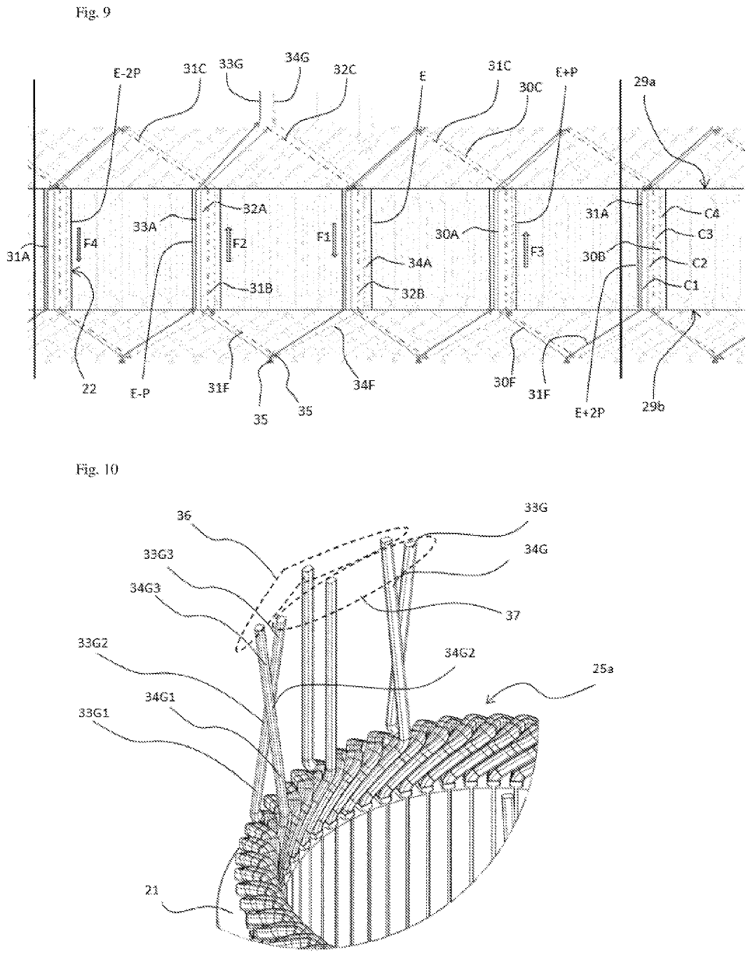

FIG. 9 partially shows an electrical diagram of the winding of the stator of FIG. 2.

FIG. 10 schematically shows a partial perspective view of the stator according to one example of the invention.

FIG. 11 respectively and schematically shows an axial top view of a portion of the winding comprising interconnection tracks according to the example of FIG. 10.

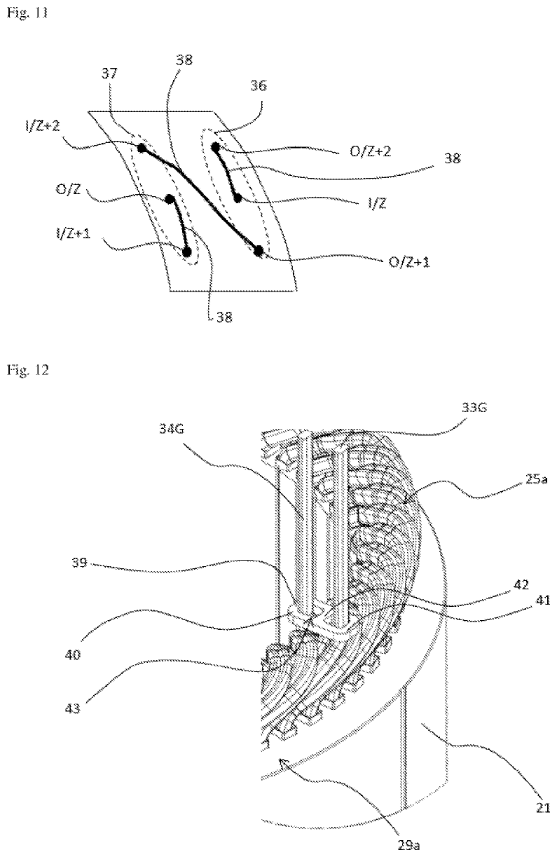

FIG. 12 schematically shows an example of a retaining member.

Elements that are identical or similar have the same references in all the figures. It will also be noted that the different figures are not necessarily to the same scale.

FIG. 1 shows an example of a compact multi-phase rotary electric machine 10, in particular for a motor vehicle. This machine 10 converts mechanical energy into electrical energy, in alternator mode, and can operate in motor mode in order to convert electrical energy into mechanical energy. This rotary electric machine 10 is, for example, an alternator, a starter-alternator, a reversible machine or an electric motor.

In this example, the machine 10 comprises a casing 11. Inside this casing 11, it also comprises a shaft 13, a rotor 12 rigidly connected to the shaft 13 for rotation therewith and a stator 15 surrounding the rotor 12. The rotor 12 rotates about an axis X. In the rest of the description, the axial direction corresponds to the axis X, passing through the center of the shaft 13, while the radial orientations correspond to planes concurrent, and in particular perpendicular, to the axis X. For the radial directions, “internal” corresponds to an element oriented toward the axis, or closer to the axis relative to a second element, and “external” denotes distance from the axis.

In this example, the casing 11 comprises a front flange 16 and a rear flange 17, which are assembled together. These flanges 16, 17 are hollow and each centrally support a bearing coupled to a respective ball bearing 18, 19 in order to allow the shaft 13 to rotate. In addition, the casing 11 comprises fixing means 14 making it possible to mount the rotary electric machine 10 in the vehicle.

A drive component 20, such as a pulley or a sprocket, can be fixed to a front end of the shaft 13. This component allows the rotational movement to be transmitted to the shaft or allows the shaft to transmit its rotational movement. In the rest of the description, the terms front/rear refer to this component. Thus, a front face is a face oriented toward the component, whereas a rear face is a face oriented in the opposite direction to said component.

The front flange 16 and the rear flange 17 are in this case arranged so as to form a chamber for circulating a coolant, such as water or oil. Alternatively, the flanges could comprise openings for the passage of a cooling air flow generated by the rotation of at least one fan rigidly connected to the rotor or the shaft for rotation therewith.

In this example, the rotor 12 is formed by a pack of sheets housing permanent magnets forming the magnetic poles. Alternatively, the rotor could be a claw rotor comprising two polar wheels and a rotor coil.

In this embodiment, the stator 15 comprises a body 21 formed by a pack of sheets provided with slots 22, equipped with slot insulator 23 for mounting an electrical winding 24. The winding passes through the slots of the body 21 and forms a front bundle 25a and a rear bundle 25b on either side of the body of the stator. Furthermore, the winding 24 is formed by one or more phase(s) comprising at least one electrical conductor and being electrically connected to an electronic assembly 26.

The electronic assembly 26, which in this case is mounted on the casing 11, comprises at least one electronic power module making it possible to control at least one phase of the winding 24. The power module forms a voltage rectifier bridge for converting the alternating voltage generated into a direct voltage, and vice versa. Alternatively, the electronic assembly could be remote from the machine.

FIGS. 2 and 3 show the stator 15 in greater detail. The body of the stator 21 is formed by an annular yoke 27 around the axis X and by a plurality of teeth 28 extending radially toward the center of the stator from the yoke, and in particular in this case from a lateral face forming an internal wall of the yoke 27. The teeth 28 are evenly angularly distributed over the periphery of the annular body, with successive spaces provided between them so as to define the slots 22 extending in series over the periphery of the annular body of the stator, each slot being defined by two successive teeth. According to the present example, the teeth 48 define slots distributed along the circumference of the stator body, these slots being arranged so as to form a support for the electrical winding 24. As a variant, a different number of slots can be used, such as 96, 84, 72, 60. It will be understood that this number particularly depends on the application of the machine, the diameter of the stator and the number of poles of the rotor.

In the axial direction, that is, the direction parallel to the axis X, the slots 22 are open on a first axial end face 29a and a second axial end face 29b of the stator body 21. In other words, the slots pass axially right through the body and open onto the two opposite axial end faces of the stator. The term “axial end faces” is given to mean faces perpendicular or substantially perpendicular to the axis of rotation X of the stator.

The winding 24 is formed by a plurality of pins electrically connected together to form electrical paths forming the phases of the winding. In this example, each phase comprises a plurality of conductive pins 30, 31, a connecting pin 32 and two power supply pins 33, 34. As will be described in further detail hereafter with reference to FIGS. 4 and 5, each conductive pin 30, 31 is formed by two conductive segments 30A, 30B, 31A, 31B extending axially in the slots 22 and which to this end are substantially parallel to each other. Said conductive segments are connected together by means of an elbow joint 30C, 31C, which is also conductive so as to form electrical continuity. As will be described in further detail hereafter with reference to FIG. 6, the connecting pin 32 is formed by two conductive segments 32A, 32B extending axially in the slots 22 and which to this end are substantially parallel to each other. Said conductive segments are connected together by means of an elbow joint 32C, which is also conductive so as to form electrical continuity. The conductive segments 30A, 30B, 31A, 31B, 32A, 32B of the same pin 30, 31, 32 are positioned in two slots distinct from each other.

Each elbow joint 30C, 31C, 32C can have two inclined portions 30D, 31D, 32D that meet to form a vertex 30E, 31E, 32E. Here, the elbow joints 30C, 31C, 32C are of one-piece construction and in particular are integrally formed with the associated conductive segments. Each pin 30, 31, 32 is thus formed in one U-shaped piece. Alternatively, the elbow joints can be formed in two portions that are connected together for example by welding, each portion of the elbow joint being integrally formed with the associated conductive segment. Each pin 30, 31, 32 is thus formed by two sub-pins, each one being I-shaped.

As will be described in further detail hereafter with reference to FIGS. 7 and 8, the power supply pins 33, 34 are each formed by a conductive segment 33A, 34A extending axially in the slots 22.

As shown in FIG. 3, the various conductive segments positioned in the same slot are superposed in order to form a stack of N layers Ci, it being understood that these N layers are present in each of the slots so that substantially coaxial annular circles are formed on the periphery of the stator. For example, there are four of these layers and they are numbered from C1 to C4, according to their stacking order in the slots 22. The first layer C1 corresponds to the external layer, the second layer C2 corresponds to an external central layer directly adjacent to the first layer C1, the third layer C3 corresponds to the internal central layer directly adjacent to the second layer C2 and the fourth layer C4 corresponds to the internal layer. The layers C1 and C4 form edge layers and the layers C2 and C3 form central layers. The first layer C1 is thus occupied by the conductive segment closest to the yoke 27 and the layer C4 is thus occupied by the conductive segment closest to the slot opening, that is, closest to the axis X. Of course, the invention is not limited to this single embodiment so that a greater number of conductive segments can be stacked in each slot, for example, 6, 8 or 10 conductors. For example, a layer is formed by a single conductive segment. Thus, each slot 22 comprises N conductive segments radially aligned relative to each other on a single line and each forming a layer Ci. In the example shown, the conductive segments each have a substantially rectangular section facilitating their stacking in the slot.

FIGS. 4, 5, 6 and 7 show the various shapes of pins forming the electrical winding 24. The following description is provided with respect to one phase of the electrical winding; a person skilled in the art will understand that all the phases are formed identically. The conductive pins 30, 31 forming the first or the second groups of pins differ by the free ends 30F, 31F of the conductive segments, axially opposite the elbow joints 30C, 31C.

FIG. 4 shows a conductive pin 30 of the first group of pins, all the pins 30 of the first group having an identical shape. This conductive pin 30 is characterized by two free ends 30F of conductive segments that are curved so as to come closer to each other. More particularly, the free ends 30F of the conductive segments are bent so as to overlap each other in a radial direction. The spacing between the two free ends 30F of the conductive segments of the same pin 30 is smaller than the spacing between these two conductive segments 30A, 30B on their straight portion housed in the slots. FIG. 5 shows a conductive pin 31 of the second group of pins, with all the pins 31 of the second group having an identical shape. This conductive pin 31 is characterized by two free ends 31F of conductive segments that are curved so as to diverge from each other. The spacing between the two free ends 31F of the conductive segments of the same pin 31 is greater than the spacing between these two conductive segments 31A, 31B on their straight portion housed in the slots. More particularly, the conductive segments 31A, 31B of the same pin are spaced apart by a step P so as to be respectively inserted into a slot E and into a slot E+P, and the free ends 31F of these conductive segments are spaced apart by a step 2P.

FIG. 6 shows a connecting pin 32 that is particularly characterized by two free ends 32F of conductive segments that are curved so as to maintain the same spacing as the conductive segments 32A, 32B. The spacing between the two free ends 32F of the conductive segments of the same pin 32 is similar to the spacing between these two conductive segments 32A, 32B on their straight portion housed in the slots. More particularly, the conductive segments 32A, 32B of the same pin are spaced apart by a step P so as to be respectively inserted into a slot E and into a slot E+P, and the free ends 32F of these conductive segments are spaced apart by the same step P.

FIG. 7 shows a first power supply pin 33, comprising a single conductive segment 33A, a first end 33G, known as the power supply end, and a second end 33F, known as the free end. The free end 33F is positioned on the same side of the stator as the free ends 30F, 31F, 32F of the other pins, and the power supply end 33G is positioned on the axially opposite side, that is, on the side of the elbow joints 30C, 31C, 32C. The ends 33F, 33G are bent in opposite circumferential directions, that is, said ends are not axially superposed.

FIG. 8 shows a second power supply pin 34 comprising a single conductive segment 34A, a first end 33G, known as the power supply end, and a second end 33F, known as the free end. The free end 34F is positioned on the same side of the stator as the free ends 30F, 31F, 32F of the other pins, and the power supply end 34G is positioned on the axially opposite side, that is, on the side of the elbow joints 30C, 31C, 32C. The ends 34F, 34G are bent in the same circumferential directions, that is, said ends are axially superposed.

The particular arrangement of the power supply ends 33G, 34G will be described in greater detail hereafter with reference to FIG. 10.

As shown in FIGS. 2 and 9 in particular, each pin 30, 31, 32, 33, 34 is arranged so that its conductive segments extend in two distinct slots E and E+P, separated by a step P, and each elbow joint is positioned on the first axial end face 29a, while the free ends are positioned on the second axial end face 29b and are connected together so as to generate electrical continuity in the winding from one pin to the other. As will be described below with reference in particular to FIG. 9, the free conductive-segment ends arranged in a first layer C1 and the free conductive-segment ends arranged in a second layer C2 are interconnected and the free conductive-segment ends arranged in a third layer C3 and the free conductive-segment ends arranged in a fourth layer C4 are interconnected. These connections are made by welding, for example. Thus, the conductive segments 30A, 30B, 31A, 31B, 32A, 32B, 33A, 34A of the same pin are connected together at one of the ends thereof by an elbow joint 30C, 31C, 32C and each is connected to another pin at the free end thereof 30F, 31F, 32F, 33F, 34F.

The first group of conductive pins 30 forms a group known as the outer group, which comprises the pins 30 the conductive segments 30A, 30B of which are housed in the slots so as to form the external first layer C1 and the internal central third layer C3. The second group of conductive pins 31 forms a group known as the inner group, which comprises the pins 31 the conductive segments 31A, 31B of which are housed in the slots so as to form the internal fourth layer C4 and the external central second layer C2.

As shown in FIGS. 2 and 9, the two groups of pins are interleaved, that is, arranged so that one of the conductive segments of the pins 30 of the outer group is located in the slots further inside than one of the conductive segments of the pins 31 of the inner group. More particularly, a conductive pin 30 belonging to the first group is arranged in the stator so as to have one conductive segment 30A occupying a first layer C1 in a slot E and one conductive segment 30B occupying a third layer C3 in a slot E+P. Similarly, a conductive pin 31 belonging to the second group is arranged in the stator so as to have one conductive segment 31A occupying a second layer C2 in the slot E and one conductive segment 31B occupying a fourth layer C4 in a slot E+P. In other words, the conductive pins 30, 31 are arranged so that the conductive segments of the same conductive pin occupy distinct slots with a radial offset of two layers from one slot to the other, or in other words with the insertion of an intermediate layer between the two layers occupied by the conductive segments of this same pin. This radial offset corresponds to the insertion of a conductive segment belonging to a conductive pin of the other group. The result of this particular arrangement is the alignment of the elbow joints on the first axial end face 29a of the stator body 21 so that the adjacent elbow joints are substantially parallel to each other. This makes it possible to increase the compactness of the bundle.

These two groups of conductive pins 30, 31 respectively form continuous electrical paths that are independent of each other. To ensure electrical continuity within the phase, a connecting pin 32 is arranged to electrically connect the first group of conductive pins 30 to the second group of conductive pins 31 and to thus form a single electrical path and form a phase of the electrical winding 24. This connecting pin 32 thus closes the electrical circuit and allows suitable flow of the current through the winding, in particular so that the current flows in the same direction in each of the conductive segments housed in the same slot, and the current generally flows in one direction in one slot and in the opposite direction in the slots spaced apart by a step P and −P.

In the example illustrated in FIG. 9, the first conductive segment 32A of the connecting pin 32 is positioned in one of the layers associated with the first group of conductive pins 30 and the second conductive segment 32B of said pin is positioned in one of the layers associated with the second group of conductive pins 31. This arrangement provides advantages with respect to the electrical connection of the winding. It makes it possible to connect all the conductive pins 30, 31 via a U-shaped connecting pin 32, that is, with a similar shape to the conductive pins with two conductive segments connected together by an elbow joint. With this arrangement, the electrical winding 24 does not therefore comprise a special pin making it possible to reverse the direction of the current in order to comply with the direction of flow of the electric current in the slots. This thus makes it possible to simplify the electrical winding and its assembly method.

In particular, in this example, the first conductive segment 32A of the connecting pin 32 is positioned in the third layer C3 and the second conductive segment 32B of said pin is positioned in the second layer C2. The conductive segments 32A, 32B of the connecting pin are thus arranged in two adjacent layers in a radial direction of two different slots, that is, an intermediate layer is not inserted between the two layers occupied by the conductive segments of this same pin 32. This makes it possible to incorporate the elbow joint 32C of the connecting pin into the bundle and not increase the height of the bundle by passing above another pin portion.

As shown in FIGS. 2, 3 and 9, power supply pins 33, 34 are positioned in a slot so that their respective conductive segments 33A, 34A are positioned in a layer adjacent to the layer of the same slot comprising the conductive segment 32A, 32B of a connecting pin 32. In other words, for each conductive segment of a connecting pin 32 occupying a second layer C2 in a slot E, a conductive segment 33A of a power supply pin 33 is provided in order to occupy a first layer C1 in said slot E. Similarly, for each conductive segment of a connecting pin 32 occupying a third layer C3 in a slot E+P, a conductive segment 34A of a power supply pin 34 is provided to occupy a fourth layer C4 in said slot E+P, spaced apart by a step P relative to said slot E. The power supply pins 33, 34 are thus positioned in edge layers so as to surround the connecting pin 32 of the same phase, the conductive segments 32A, 32B of which are positioned in central layers.

It will be understood that each connecting pin 32 is associated with a pair of power supply pins 33, 34, as shown in FIG. 2 in particular. An electrical winding 24 comprising six phases thus also comprises six pairs of power supply pins 33, including six first power supply pins 33 and six second power supply pins 34, and six connecting pins 32. It will be understood that the number of conductive pins 30, 31 depends on the number of slots of the stator and therefore on the desired application of the rotary electric machine, and in particular on the desired performance and the available space, given that there are as many conductive pins 30 in the first group as there are conductive pins 31 in the second group.

The power supply ends 33G, 34G form current inputs and/or outputs of the corresponding phase. More specifically for a phase, one end 33G, 34G of one of the power supply pins is connected, directly or by means of an interconnection device, to one end 33G, 34G of a power supply pin of another phase of the winding and/or to a current source included in particular in an electronic power and/or control module of the electronic assembly 26.

The power supply pins 33, 34 are arranged along the electrical winding 24 in the external first layer C1 and in the internal fourth layer C4. In particular, the first power supply pins 33 and their power supply end 33G are positioned in the external layer C1 and the second power supply pins 34 and their power supply end 34G are positioned in the internal layer C4. It is of course possible to reverse this positioning of the power supply pins without departing from the scope of the invention.

FIG. 10 shows an embodiment of the invention illustrating a portion of the winding of the stator and particularly the bundle from which the power supply ends 33G, 34G extend. In particular in this example, four of the six power supply ends 33G, 34G each have an intersecting portion 33G2, 34G2 and the other two power supply ends 33G, 34G do not have an intersecting portion and extend in a substantially axial direction from their associated conductive segment 33A, 34A. In this example, the power supply ends that do not have an intersecting portion are arranged circumferentially between the power supply ends having intersecting portions.

In an alternative example, not shown, only two of the six power supply ends 33G, 34G can each have an intersecting portion 33G2, 34G2 and the other four power supply ends 33G, 34G do not have an intersecting portion. In this case, the power supply ends having intersecting portions could be arranged circumferentially between the power supply ends that do not have intersecting portions.

Each of said four power supply ends has a linking portion 33G1, 34G1 adjacent to the associated conductive segment 33A, 34A, a connecting portion 33G3, 34G3 electrically connected to the electronic assembly 26 and an intersecting portion 33G2, 34G2 arranged between said associated linking and connecting portions. Said portions extend continuously one after the other from the conductive segment of the same power supply pin and form a substantially straight line that extends inclined relative to an axial direction. This inclined straight line extends from one of the peripheries of the winding to the radially opposite periphery. Said linking and connecting portions of the same power supply end are thus opposite each other, in a radial direction relative to the intersecting portion of said same power supply end, which forms a substantially radially central portion between the inner periphery and the outer periphery of the winding.

Two power supply pins 33, 34 the conductive segments of which extend in the same slot 22, have power supply ends of the same type, that is, of the type comprising an intersecting portion or of the type that does not comprise an intersecting portion. The intersecting portions 33G2, 34G2 of power supply ends of pins arranged in the same slot thus extend facing and at a distance from each other in a circumferential direction. There is therefore no contact between the intersecting portions. This spacing is in particular of the order of a few millimeters.

The intersecting portions 33G2, 34G2 are arranged at a distance from an axial end of the bundle 25a from which the power supply ends extend. Said intersecting portions are therefore axially spaced apart from the axial end of the bundle. This axial spacing is for example between 5 mm and 35 mm.

In the example illustrated here, the power supply end 33G has a linking portion 33G1 extending from an outer periphery of the winding and a connecting portion 33G3 extending to an inner periphery of said winding. Similarly, the power supply end 34G has a linking portion 34G1 extending from an inner periphery of the winding and a connecting portion 34G3 extending to an outer periphery of said winding. The power supply ends of a single slot are therefore reversed.

In this exemplary embodiment, the output of one phase is connected to the input of another phase of the same phase system in order to achieve a delta configuration. Each of these connections between the phase inputs and outputs is also connected to a current source included in particular in an electronic power and/or control module of the electronic assembly 26.

The power supply ends 33G, 34G are arranged along the electrical winding 24 so that their connecting portions 33G3, 34G3 are grouped into a first set 36 and a second set 37 for each phase system. In this example, the connecting portions of the same set are axially aligned with the same layer Ci of the slot. For example here, as illustrated in FIG. 10, the first set 36 comprises connecting portions positioned above the external layer C1 and the second set comprises connecting portions positioned above the internal layer C4. In one alternative embodiment, it is possible to have the connecting portions of the first set positioned in the internal layer C4, and the connecting portions of the second set positioned in the external layer C1. It is also possible to position the connecting portions in the central layers C2, C3.

Still in the example described here, the electrical winding 24 comprises two systems each comprising three phases. Thus, the winding here comprises two first sets 36 and two second sets 37 each comprising three connecting portions 33G3, 34G3. The structures of the sets can be identical or different from one phase system to another. Each of the sets 36, 37 comprises at least one connecting portion forming a phase input and one connecting portion forming a phase output. In particular in this example, each set 36, 37 comprises either two connecting portions forming phase inputs and one connecting portion forming a phase output or two connecting portions forming phase outputs and one connecting portion forming a phase input. The sets of the same phase system have architectures that are complementary to one another. For example, if the first set comprises two phase inputs and one phase output, then the second set comprises two phase outputs and one phase input. In addition, each set comprises one connecting portion per phase of said phase system. Thus, for the same set, each connecting portion belongs to a different phase.

FIG. 11 shows an example in which the first set 36 comprises two connecting portions forming phase outputs and one connecting portion forming a phase input and the second set 37 comprises two connecting portions forming phase inputs and one connecting portion forming a phase output. The connecting portions are arranged in the same layer of the slot and therefore extend over one circumferential portion of the winding.

In this exemplary embodiment, within a given set, the ends forming the phase outputs/inputs are alternated, in a circumferential direction. In other words, for a set comprising two phase outputs and one phase input, said phase input is positioned circumferentially between the phase outputs. Similarly, for a set comprising two phase inputs and one phase output, said phase output is positioned circumferentially between the phase inputs.

Preferably, the distance in a circumferential direction between the power supply ends is identical within the same set 36, 37.

For example, the same set 36, 37 comprises at least one connecting portion 33G3 and at least one connecting portion 34G3 belonging to two different power supply pins 33, 34. Here, this alternation of the phase inputs/outputs within the same set is created by the reversal of the connecting portions 33G3, 34G3 for only some of the power supply ends of the phase system, namely the power supply ends having an intersecting portion. Thus, for a phase, if the first set comprises the connecting portion forming the phase output then the second set comprises the connecting portion forming the phase input.

FIG. 11 illustrates an example in which the first set 36 comprises, in the following order: the connecting portion forming the output O/Z+2 of the third phase, then the connecting portion forming the input I/Z of the first phase, then the connecting portion forming the output O/Z+1 of the second phase. The second set 37, which is complementary to said first set 36, then comprises, in the following order: the connecting portion forming the input I/Z+2 of the third phase, then the connecting portion forming the output O/Z of the first phase, then the connecting portion forming the input I/Z+1 of the second phase.

To achieve a delta configuration, the power supply ends 33G, 34G are interconnected, here for example by means of an interconnection track 38. Each interconnection track is for example welded to the associated connecting portions and can comprise a portion for connection with a module of the electronic assembly 26. The tracks 38 are for example overmolded in an electrically insulating material to make it easier to make these connections and to guarantee good electrical insulation between them and between said tracks and the vertices 30E, 31E, 32E of the other pins of the winding. More particularly, the connecting portion forming the phase input I/Z+2 of the third phase is connected to the connecting portion forming the phase output O/Z+1 of the second phase, the connecting portion forming the phase output O/Z of the first phase is connected to the connecting portion forming the phase input I/Z+1 of the second phase, and the connecting portion forming the phase output O/Z+3 of the third phase is connected to the connecting portion forming the phase input I/Z of the first phase. As shown clearly in FIG. 11, it is possible to make these connections without overlap between the tracks 38.

Other types of connection can be produced without departing from the scope of the invention, particularly by swapping the order of the phases.

In order to retain in a radial direction the power supply ends 33G, 34G that do not have an intersecting portion, a retaining member 39 can be arranged between said ends and thus prevent said ends from moving, in particular outward or inward in a radial direction relative to the axis X.

In the example illustrated in FIG. 12, the retaining member 39 therefore retains two power supply ends that are positioned in the same slot and on different edge layers, each of the layers forming a radial end of the winding.

For example, the retaining member 39 is mounted in contact with the axial end of the rear bundle 25a extending axially toward the electronic assembly 26. A radial face of the retaining member 39 acting as a bearing surface is therefore in contact with at least one vertex 30E, 31E, 32E of one of the pins 30, 31, 32. As a variant, the retaining member could be mounted at a distance from the bundle and not therefore be in contact with it.

In the example illustrated here, the electrical winding 24 comprises only two power supply ends that do not have an intersecting portion, and the winding then comprises a single retaining member 39. In the alternative example, not illustrated, described above, in which the electrical winding 24 comprises four power supply ends that do not have an intersecting portion, the winding could then comprise two retaining members 39, one for each pair of ends.

The retaining member can comprise a first portion 40 making it possible to retain the power supply end 33G of the first power supply pin 33, and a second portion 41 making it possible to retain the power supply end 34G of the second power supply pin 34, and a linking portion 42 arranged between said portions 40, 41. The linking portion is arranged radially between said two portions.

FIG. 12 illustrates an example of a retaining member 39 in the shape of a bar comprising two axial through-holes 43 each of which allows the insertion of one of the power supply ends 33G, 34G. Alternatively, the retaining member 39 could be in the shape of a bar comprising two slots each allowing the insertion, particularly by snap-fastening, of the power supply ends 33G, 34G.

The retaining member 39 is made from an electrically insulating material such as plastic. The retaining member can be formed in a single piece, that is, the first portion 40, the second portion 41 and the linking portion 42 are integrally formed to produce a one-piece part.

FIG. 9 shows a schematic illustration of part of a winding in accordance with the previous description. For the sake of simplicity, the number of slots has been limited, and it will be understood that the following description can be easily extended by a person skilled in the art in order to produce the complete winding, with the other slots of the stator also comprising stacks of conductive segments.

Still for the sake of simplicity, the pins of the same phase are shown in bold, with the pins of the other phases being transparent.

More specifically, for the electrical circuit illustrated in FIG. 9, current is introduced, in a first direction of orientation, into the winding 24 by means of the power supply end 34G of a first power supply pin 34 forming the input of the electric current of the phase, illustrated on the side of the first axial end face 29a. Its path will be described in more detail via the numbered arrows Fi, in order to illustrate the fact that the current flows, through stacked conductive segments, in the same direction for a given slot, and in an opposite direction for a slot spaced apart by a step P or −P. It should be noted that the slot E+P is spaced apart from the slot E by a predetermined step P, in a first direction of orientation. In the present example of a dual-three-phase electrical winding with one slot per pole and per phase, the step P corresponds to the insertion of five slots between a slot E and a slot E+P.

The current flows in the conductive segment 34A housed in a slot E from the first axial end face 29a to the second axial end face 29b (arrow F1). This conductive segment 34A, arranged so as to form part of the fourth layer C4 in this slot E, has, at its free end 34F, on the side of the second axial end face 29b, a shape folded on itself that is similar to that of a conductive segment 30F of a conductive pin 30 of the first group of pins that it replaces in this layer.

The free end 34F of the power supply pin is connected, on the second axial end face 29b of the stator, to the free end 31F of a conductive pin 31 of the second group of pins, one of the conductive segments of which occupies the third layer C3 in a slot E−P. The two free ends 34F, 31F are arranged next to each other, in particular in a radial direction, and are electrically connected at a contact point 35, with this contact point being able to be produced by welding, so as to allow an electric current to flow through the conductive segments, in the same direction, in each slot. The direction of flow of the current is shown by the arrows overlapping the conductive pins. As a result, the current is made to flow, from the second axial end face 29b to the first axial end face 29a, via the conductive segment 31B in the third layer C3 of the slot E−P, such as illustrated by the arrow F2.

The conductive segment 31B, occupying the third layer C3 in the slot E−P, forms part of a conductive pin 31 belonging to the second group of pins so that this conductive segment is extended, on the first axial end face 29a, by means of an elbow joint 31C, into a conductive segment 31A occupying the first layer C1 in a slot E−2P separated by a space P relative to the slot E−P, in the opposite direction to the first orientation direction. The current is thus made to flow, from the first axial end face 29a to the second axial end face 29b, via the conductive segment 31A in the first layer C1 of the slot E−2P, as illustrated by the arrow F4.

It will be understood that, for a given phase, the pins are successively interleaved around the entire perimeter of the stator, and that, to simplify the understanding of FIG. 9, the above description will resume, after the current has flowed substantially all the way around the stator, at the solid line positioned between the slots E+P and E+2P in FIG. 9.

At this stage, the winding continuity is achieved by connecting the free end 31F of the conductive segment 31A occupying the first layer C1 in the slot E+2P to the free end 30F of a conductive segment 30A occupying the second layer C2 in the slot E+P, with said ends 31F, 30F being arranged side-by-side in a radial direction and electrically connected by a contact point 35 on the second axial end face 29a.

The current is thus made to make a loop in the first direction of orientation and flow from the second axial end face 29b toward the first axial end face 29a, in the second layer C2 of the slot E+P, via the conductive segment 30A of a conductive pin 30 of the first group of pins, as illustrated by the arrow F3, then flow through the elbow joint 30C of said conductive pin 30, then flow from the first axial end face 29a toward the second axial end face 29b, in the fourth layer C4 of the slot E+2P via the conductive segment 30B of said conductive pin 30. It can be seen from the above that, in the slot E+2P, the currents flowing in the first layer C1 and in the fourth layer C4 both flow in the same direction.

The current then flows successively in a direction opposite to the first orientation direction, via a contact point 35, to a conductive segment 31B housed in the third layer C3 of the slot E+P and then via the elbow joint 31C to a conductive segment 31A of the same conductive pin 31 in the first layer C1 of the slot E.

At this stage, the current is made to flow, following a contact point 35, from the second axial end face 29b toward the first axial end face 29a in the first direction of orientation, in the second layer C2 of the slot E via a conductive segment 32A of the connecting pin 32 then, following the elbow joint 32C, from the first axial end face 29a toward the second axial end face 29b, in the third layer C3 of the slot E+P via a conductive segment 32B of said connecting pin 32.

The continuity of the winding is then achieved, according to the description above, by passing from a conductive segment of the first layer C1 to the third layer C3 and from the fourth layer C4 to the second layer C2 on the side of the elbow joints forming part of the conductive pins, and by passing from the second layer C2 to the first layer C1 and from the third layer C3 to the fourth layer C4 through contact points 35, in particular welds, on the second axial end face 29b, so that the flow of the current in the same direction in each slot is achieved.

The current is then made to flow, in accordance with the description above, from one conductive pin to the other, until it flows into slot E−P in the first layer C1, in which is arranged the conductive segment 33A of the power supply pin 33 forming via its power supply end 33G the current output of the illustrated phase.

The present invention is particularly applicable in the field of alternators, starter-alternators, electric motors, or even reversible machines, but it could equally be applied to any type of rotary machine.

Of course, the above description has been provided by way of example only and does not limit the field of the present invention, which field will not be departed from by replacing the different elements with any other equivalent elements.

1. An electrical winding for an active part, particularly formed by a stator or a rotor, of a rotary electric machine, the active part comprising a body having an annular yoke about an axis (X) and a plurality of teeth extending from a lateral face of the yoke in a radial direction so as to define slots, said slots opening onto a first axial end face and onto a second axial end face of the body; the electrical winding having at least one phase system comprising a plurality of electrical phases each including a set of pins that are electrically connected to one another and that each have at least one conductive segment, said conductive segments being suitable for being housed in the same slot forming N layers (Ci), said set of pins comprising at least one first power supply pin and one second power supply pin each forming a phase input or output, each power supply pin comprising a power supply end extending from the associated conductive segment to outside the slot, the winding being wherein at least one portion of a first power supply end is arranged on an inner periphery of the winding, said first end extending a conductive segment arranged in an external layer, and in that at least one portion of a second power supply end is arranged on an outer periphery of the winding, said second end extending a conductive segment arranged in an internal layer, the inner periphery being closer to the axis (X) than the outer periphery and said internal and external layers forming edge layers.

2. The electrical winding as claimed in claim 1, wherein the conductive segments of said first and second power supply pins are arranged in the external layer and in the internal layer of the same slot respectively.

3. The electrical winding as claimed in claim 1, wherein the first end and the second end are spaced apart from each other in a circumferential direction.

4. The electrical winding as claimed in claim 1, wherein said first and second power supply ends each have a linking portion adjacent to the associated conductive segment, a connecting portion suitable for being connected to an electronic assembly of the electric machine and an intersecting portion arranged between said associated linking and connecting portions, said linking and connecting portions of the same power supply end being on opposite sides of the intersecting portion of said same power supply end in a radial direction and the intersecting portions of the first and second power supply ends extending facing each other, in a circumferential direction.

5. The electrical winding as claimed in claim 4, wherein the pins are suitable for forming bundles on either side respectively of the axial end faces of the stator body and in that the intersecting portions are arranged axially at a distance from the bundles.

6. The electrical winding as claimed in claim 4, wherein the intersecting portions extend between the outer periphery and the inner periphery of the winding and particularly in a radially central portion between said peripheries.

7. The electrical winding as claimed in claim 4, wherein a first set, arranged on one of the peripheries of the winding and made up of power supply pins of different phases, comprises at least one power supply end having an intersecting portion and at least one other power supply end that does not have an intersecting portion and in that a second set, arranged on a different periphery of the winding from the first set and made up of power supply pins of different phases, comprises at least one power supply end having an intersecting portion and at least one other power supply end that does not have an intersecting portion.

8. The electrical winding as claimed in claim 7, wherein, in a set comprising at least three first ends, only two or one of said ends have/has an intersecting portion.

9. The electrical winding as claimed in claim 8, wherein when a set comprises two power supply ends having intersecting portions, the power supply end that does not have an intersecting portion is arranged circumferentially between said power supply ends having an intersecting portion, and in that when a set comprises one power supply end having an intersecting portion, said power supply end having the intersecting portion is arranged circumferentially between the power supply ends that do not have an intersecting portion.

10. A rotary electric machine comprising an active part, particularly formed by a stator or a rotor, comprising an electrical winding as claimed in claim 1.

11. The electrical winding as claimed in claim 2, wherein the first end and the second end are spaced apart from each other in a circumferential direction.

12. The electrical winding as claimed in claim 2, wherein said first and second power supply ends each have a linking portion adjacent to the associated conductive segment, a connecting portion suitable for being connected to an electronic assembly of the electric machine and an intersecting portion arranged between said associated linking and connecting portions, said linking and connecting portions of the same power supply end being on opposite sides of the intersecting portion of said same power supply end in a radial direction and the intersecting portions of the first and second power supply ends extending facing each other, in a circumferential direction.

13. The electrical winding as claimed in claim 5, wherein the intersecting portions extend between the outer periphery and the inner periphery of the winding and particularly in a radially central portion between said peripheries.

14. The electrical winding as claimed in claim 5, wherein a first set, arranged on one of the peripheries of the winding and made up of power supply pins of different phases, comprises at least one power supply end having an intersecting portion and at least one other power supply end that does not have an intersecting portion and in that a second set, arranged on a different periphery of the winding from the first set and made up of power supply pins of different phases, comprises at least one power supply end having an intersecting portion and at least one other power supply end that does not have an intersecting portion.

15. A rotary electric machine comprising an active part, particularly formed by a stator or a rotor, comprising an electrical winding as claimed in claim 2.

16. The electrical winding as claimed in claim 3, wherein said first and second power supply ends each have a linking portion adjacent to the associated conductive segment, a connecting portion suitable for being connected to an electronic assembly of the electric machine and an intersecting portion arranged between said associated linking and connecting portions, said linking and connecting portions of the same power supply end being on opposite sides of the intersecting portion of said same power supply end in a radial direction and the intersecting portions of the first and second power supply ends extending facing each other, in a circumferential direction.

17. The electrical winding as claimed in claim 6, wherein a first set, arranged on one of the peripheries of the winding and made up of power supply pins of different phases, comprises at least one power supply end having an intersecting portion and at least one other power supply end that does not have an intersecting portion and in that a second set, arranged on a different periphery of the winding from the first set and made up of power supply pins of different phases, comprises at least one power supply end having an intersecting portion and at least one other power supply end that does not have an intersecting portion.

18. A rotary electric machine comprising an active part, particularly formed by a stator or a rotor, comprising an electrical winding as claimed in claim 3.

19. A rotary electric machine comprising an active part, particularly formed by a stator or a rotor, comprising an electrical winding as claimed in claim 4.

20. A rotary electric machine comprising an active part, particularly formed by a stator or a rotor, comprising an electrical winding as claimed in claim 5.
